(19) United States
(12) Patent Application Publication
(10) Pub. No.: US 2024/0316499 A1
(43) Pub. Date: Sep. 26, 2024

(54) SYSTEM AND METHOD FOR PREDICTIVE ANALYSIS FOR SEAWATER REVERSE OSMOSIS (SWRO) DESALINATION PLANTS

(71) Applicant: ACWA POWER Company, Riyadh (SA)

(72) Inventors: Ratul DAS, Thuwal (SA); Muhammad Ghifari RIDWAN, Dubai (AE); Thomas ALTMANN, Dubai (AE); Ahmed Yousry Ahmed MAHMOUD, Dubai (AE)

(73) Assignee: ACWA POWER Company, Riyadh (SA)

(21) Appl. No.: 18/613,622

(22) Filed: Mar. 22, 2024

Related U.S. Application Data
(60) Provisional application No. 63/492,191, filed on Mar. 24, 2023.

(51) Int. Cl. B01D 61/12; B01D 61/02; B01D 61/08; B01D 65/02; C02F 1/00; C02F 1/44; C02F 103/08; G08B 21/18

(52) U.S. Cl. CPC B01D 61/12; B01D 61/025; B01D 61/08; B01D 65/02; C02F 1/008; C02F 1/441; G08B 21/187; B01D 2313/701; B01D 2313/702; B01D 2313/903; B01D 2321/40; C02F 2103/08; C02F 2209/001; C02F 2209/006; C02F 2209/008; C02F 2209/03; C02F 2209/05; C02F 2303/16

(57) ABSTRACT

A system and method for predictive analysis of Seawater Reverse Osmosis (SWRO) desalination plants receives first data associated with a SWRO plant, including a first set of parameters associated with seawater, a second set of parameters associated with a permeate, and a third set of parameters associated with a brine. The system determines a fourth set of parameters by applying normalization techniques to the received first data. The system determines, based upon the fourth set of parameters, a set of membrane performance parameters associated with the SWRO plant, or a set of diagnostic indicators associated with at least one of the SWRO plant and the seawater. The system outputs the determined set of membrane performance parameters or the set of diagnostic indicators.

### CROSS-REFERENCE TO RELATED APPLICATIONS

This application claims priority to U.S. Provisional Patent Application Ser. No. 63/492,191, filed Mar. 24, 2023, and entitled “SYSTEM AND METHOD FOR PREDICTIVE ANALYSIS FOR SEAWATER REVERSE OSMOSIS (SWRO) DESALINATION PLANTS”, the disclosure of which is incorporated herein by reference.

### TECHNOLOGICAL FIELD

The present disclosure generally relates to the seawater reverse osmosis (SWRO) desalination process, and more particularly relates to a system and a method for predictive analysis for seawater reverse osmosis (SWRO) desalination plants.

### BACKGROUND

Reverse osmosis is a widely used process for water purification, especially in areas where freshwater is scarce. In recent years, seawater reverse osmosis (SWRO) has emerged as an effective solution for providing potable water in coastal regions, islands, and arid countries. A seawater reverse osmosis process consists of different components such as pumps, membranes, valves, and energy recovery devices. The SWRO process involves passing seawater through a semi-permeable membrane under high pressure that separates the salt and other impurities from the seawater, producing freshwater. The SWRO technology has been around for a few decades.

However, a low-cost and energy-efficient desalination process is becoming critical as the operational cost in the SWRO is substantially high. One of the sources of operational cost in SWRO is membrane replacement. In addition to that, a procedure for cleaning the membrane to remove fouling includes circulating chemicals on the membrane to dissolve the fouling matter. However, the efficacy of the procedure is highly dependent on timing and the type of the foulant. In addition, the conventional procedure to investigate the type of foulant may take a large amount of time as the membrane autopsy procedure requires the usage of sophisticated instruments that are not readily available in the plant.

### SUMMARY

In comparison with the traditional techniques, the present disclosure provides an improved design of a system and a method for predictive analysis for the Seawater Reverse Osmosis (SWRO) desalination plants.

In one aspect a system for predictive analysis for seawater reverse osmosis desalination plants is provided. The system may include a memory configured to store computer-executable instructions. Further, the system may include one or more processors coupled to the memory. The one or more processors may be configured to receive the first data associated with a seawater reverse osmosis (SWRO) plant. The first data may include at least one of a first set of parameters associated with seawater, a second set of parameters associated with a permeate, and a third set of parameters associated with a brine. The one or more processors may be further configured to determine a fourth set of parameters based on an application of one or more normalization techniques on the received first data. Further, the one or more processors may be configured to determine, based on the fourth set of parameters, a set of membrane performance parameters associated with the SWRO plant, or a set of diagnostic indicators associated with at least one of the SWRO plant and the seawater. The one or more processors may be further configured to output the determined set of membrane performance parameters or the set of diagnostic indicators.

In an embodiment, the one or more processors may be further configured to generate second data based on a combination of the determined set of membrane performance parameters and the determined set of diagnostic indicators. Further, the one or more processors may be configured to apply a trend recognition technique on the generated second data. The one or more processors may be further configured to determine diagnostic indicator trend in each of the set of diagnostic indicators based on the application of the trend recognition technique. Further, the one or more processors may be configured to generate a cleaning in Place (CIP) prediction to provide a CIP timeline and a diagnostic recommendation based on the determined diagnostic indicator trend.

In an embodiment, the one or more processors may be further configured to output the CIP timeline and the diagnostic recommendation on an electronic device.

In an embodiment, the one or more processors may be further configured to generate a diagnostic tree based on the second data. Further, the one or more processors may be configured to determine a root cause for a decline in performance of one or more membranes associated with the SWRO plant, based on the generated diagnostic tree. The one or more processors may be further configured to output the root cause on an electronic device.

In an embodiment, the first set of parameters associated with the seawater may include at least one of a pressure value of the seawater, a salinity value of the seawater, or a conductivity value of the seawater. The second set of parameters associated with the permeate may include at least one of a pressure value of the permeate, a salinity value of the permeate, or a conductivity value of the permeate.

In an embodiment, the third set of parameters associated with the seawater may include at least one of a pressure value of the brine, a salinity value of the brine, or a conductivity value of the brine.

In an embodiment, the one or more processors may be configured to generate validated data based on the application of one or more data validation techniques on the received first data. Further, the one or more processors may be configured to generate normalized data based on the application of the one or more normalization techniques on the validated data. The one or more processors may be further configured to determine the fourth set of parameters based on the generated normalized data.

In an embodiment, the fourth set of parameters may include at least one of Normalized Salt Passage (NSP) value associated with the one or more membranes of the SWRO plant, Normalized Differential Pressure (NDP) value associated with the one or more membranes of the SWRO plant, and Normalized Permeate Flow (NPF) value associated with the one or more membranes of the SWRO plant.

In an embodiment, the generated normalized data further may include a fifth set of parameters. The fifth set of parameters may include at least one of a water transport coefficient of one or more membranes associated with the SWRO plant, a salt transport coefficient of the one or more membranes associated with the SWRO plant, and a specific flux of the one or more membranes associated with the SWRO plant.

In an embodiment, the one or more processors may be configured to generate diagnostic data based on the fourth set of parameters. Further, the one or more processors may be configured to determine, based on the generated diagnostic data, at least one of the set of membrane performance parameters associated with the SWRO plant, or the set of diagnostic indicators associated with at least one of the SWRO plant and the seawater.

In an embodiment, the set of diagnostic indicators includes at least of a Potential of Hydrogen (pH) of the seawater, a silt density Index (SDI) of the seawater, a turbidity of the seawater, a temperature of the seawater, chorine value of the seawater, an oxidation reduction potential of the seawater, and cartridge filter (CF) pressure drop.

In an embodiment, the one or more processors may be configured to determine the set of membrane performance parameters, based on the application of the one or more normalization techniques on the generated diagnostic data. Each parameter of the set of membrane performance parameters indicates performance of the one or more membranes associated with the SWRO plant.

In an embodiment, the one or more processors may be configured to compare the value of each parameter of the set of membrane performance parameters with a corresponding threshold value. Further, the one or more processors may be configured to generate an alarm based on the comparison.

In an embodiment, the alarm may be generated based on the compared value of at least one parameter of the set of membrane performance parameters being less than the corresponding threshold value.

In an embodiment, the one or more processors may be configured to generate a notification based on the generated alarm. The generated notification may indicate the generated alarm. Further, the one or more processors may be configured to transmit the generated notification to an electronic device.

In another aspect, a method for predictive analysis for seawater reverse osmosis desalination plants is provided. The method may include receiving first data associated with a seawater reverse osmosis (SWRO) plant. The first data may include at least one of a first set of parameters associated with seawater, a second set of parameters associated with a permeate, and a third set of parameters associated with a brine. The method may further include determining a fourth set of parameters based on an application of one or more normalization techniques on the received first data. Further, the method may include determining, based on the fourth set of parameters, a set of membrane performance parameters associated with the SWRO plant, or a set of diagnostic indicators associated with at least one of the SWRO plant and the seawater. The method may further include outputting the determined set of membrane performance parameters or the set of diagnostic indicators.

In a method embodiment, the method may include generating second data based on a combination of the determined set of membrane performance parameters and the determined set of diagnostic indicators. Further, the method may include applying a trend recognition technique to the generated second data. The method may further include determining diagnostic indicator trends in each of the set of diagnostic indicators based on the application of the trend recognition technique. Further, the method may include generating a cleaning in Place (CIP) prediction to provide a CIP timeline and a diagnostic recommendation based on the determined diagnostic indicator trend.

In a method embodiment, the method may include outputting the CIP timeline and the diagnostic recommendation on an electronic device.

In a method embodiment, the method may include generating a diagnostic tree based on the second data. Further, the method may include determining a root cause for a decline in performance of the one or more membranes associated with the SWRO plant, based on the generated diagnostic tree. The method may further include outputting the root cause on an electronic device.

In yet another aspect, a non-transitory computer-readable storage medium carrying one or more sequences of one or more instructions which, when executed by at least one processor, cause the system to perform operations including receiving first data associated with a seawater reverse osmosis (SWRO) plant. The first data may include at least one of a first set of parameters associated with seawater, a second set of parameters associated with a permeate, and a third set of parameters associated with a brine. The operations may further include determining a fourth set of parameters based on an application of one or more normalization techniques on the received first data. Further, the operations may include determining, based on the fourth set of parameters, a set of membrane performance parameters associated with the SWRO plant, or a set of diagnostic indicators associated with at least one of the SWRO plant and the seawater. The operations may further include outputting the determined set of membrane performance parameters or the set of diagnostic indicators.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment in which a system for predictive analysis for seawater reverse osmosis desalination plants is implemented, in accordance with an embodiment of the disclosure;

FIG. 2 illustrates a block diagram of the system of FIG. 1, in accordance with an embodiment of the disclosure;

FIG. 3 illustrates exemplary operations for predictive analysis for SWRO desalination plants, in accordance with an embodiment of the disclosure;

FIG. 4 illustrates a flowchart for the implementation of an exemplary method for generating diagnostic recommendations for monitoring the SWRO process, in accordance with an example embodiment of the present disclosure;

FIG. 5 illustrates a flow diagram for root cause determination, in accordance with an example embodiment of the present disclosure; and

FIG. 6 illustrates an exemplary method for predictive analysis for seawater reverse osmosis desalination plants, in accordance with an embodiment.

### DETAILED DESCRIPTION

In the following description, for purposes of explanation, numerous specific details are set forth to provide a thorough understanding of the present disclosure. It will be apparent, however, to one skilled in the art that the present disclosure may be practiced without these specific details. In other instances, systems and methods are shown in block diagram form only to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

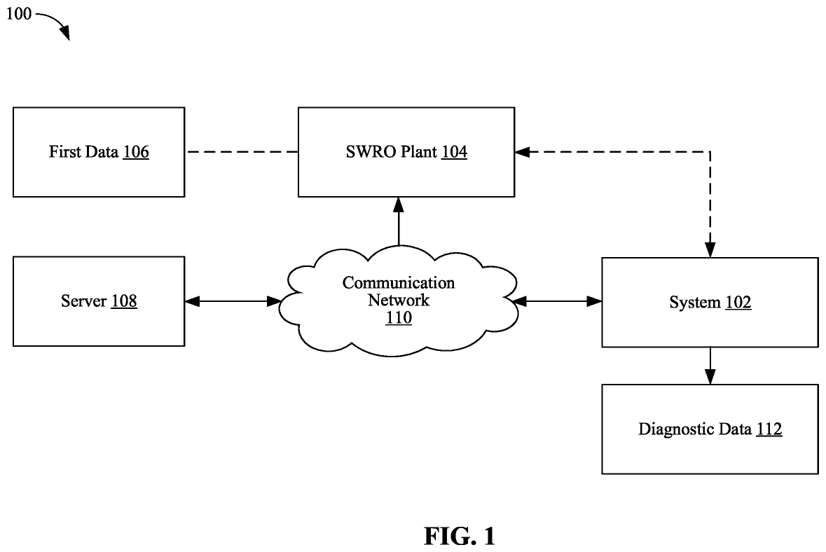

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of predictive analysis for seawater reverse osmosis desalination plants.

FIG. 1 illustrates a network environment 100 in which a system for predictive analysis for seawater reverse osmosis desalination plants is implemented, in accordance with an embodiment of the disclosure. With reference to FIG. 1, there is shown a network environment 100. The network environment 100 may include a system 102, a seawater reverse osmosis (SWRO) plant 104, first data 106 associated with the SWRO plant 104, a server 108, a communication network 110, and diagnostic data 112.

In an embodiment, the system 102 may include a plurality of sensors to receive the first data 106 associated with the Seawater Reverse Osmosis (SWRO) plant 104. The system 102 may provide means for monitoring and optimization of the SWRO plant 104. In an exemplary embodiment, the system 102 may be integrated with the SWRO plant 104. The SWRO plant 104 may be a facility that may use a reverse osmosis process to desalinate the seawater and produce freshwater for various purposes. Such various purposes may be for example, but are not limited to, drinking, irrigation, and industrial use.

In an embodiment, the first data 106 may be associated with the SWRO plant 104. In an exemplary embodiment, the first data 106 may include historical data as well as real-time (or current) data associated with the SWRO plant 104 and acquired by the plurality of sensors. Further, the first data 106 may be optionally uploaded to the server 108. The received first data 106 that may be stored on the server 108 may be accessed by the system 102 to generate the diagnostic data 112. To this end, the system 102 may be connected to the server 108 via the communication network 110.

The process of reverse osmosis in the SWRO plant 104 may involve forcing seawater through a semi-permeable membrane under high pressure, allowing pure water to pass through while retaining the salts and other contaminants. In an exemplary embodiment, the SWRO plant 104 typically consists of intake, pre-treatment, high-pressure pump, RO membrane banks, and post-treatment sections. The intake system may be a deep-sea intake, an open channel, or a well intake, depending on the SWRO plant 104 location and requirements. Pretreatment may involve removing suspended matter and colloids to protect the RO membranes that may remove impurities from the input water.

The network environment 100 may further include the server 108. The server 108 may be a specialized machine that may be designed for a specific task within the network environment 100. The server 108 may play a crucial role in responding to the system 102 request, processing data, and delivering the data efficiently. The server 108 may be designed for high-performance computing and data handling, ensuring that the system 102 requests may be handled accordingly and that the requested content is delivered to the system 102 seamlessly. Load balancing and redundancy further enhance the reliability, and the one or more servers in various locations worldwide optimize content delivery for the system 102 anywhere around the globe. For example, the server 108 may include but is not limited to, a mail server, a data server, an application server, or a database server.

A person with ordinary skill in the art will understand that the scope of the disclosure may not be limited to the implementation of the server 108 and the system 102 as two separate entities. In certain embodiments, the functionalities of the server 108 can be incorporated in its entirety or at least partially in the system 102, without a departure from the scope of the disclosure.

The communication network 110 may be wired, wireless, or any combination of wired and wireless communication networks, such as cellular, Wi-Fi, internet, local area networks, or the like. In some embodiments, the communication network 110 may include one or more networks such as a data network, a wireless network, a telephony network, or any combination thereof. It is contemplated that the data network may be any Local Area Network (LAN), Metropolitan Area Network (MAN), Wide Area Network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), Global System for Mobile communications (GSM), Internet Protocol Multimedia Subsystem (IMS), universal mobile telecommunications system (UMTS), etc., as well as any other suitable wireless medium, e.g., worldwide interoperability for microwave access (WiMAX), Long Term Evolution (LTE) networks (for example LTE-Advanced Pro), 5G New Radio networks, International telecommunication Union-International Mobile Telecommunication ITU-IMT 2020 networks, code division multiple access (CDMA), Wideband Code Division Multiple Access (WCDMA), Wireless Fidelity (Wi-Fi), wireless LAN (WLAN), Bluetooth, Internet Protocol (IP) data casting, satellite, Mobile Ad-hoc Network (MANET), and the like, or any combination thereof.

All the components in the network environment 100 may be coupled directly or indirectly to the communication network 110. The components described in the network environment 100 may be further broken down into more than one component and/or combined in any suitable arrangement. Further, one or more components may be rearranged, changed, added, and/or removed.

In operation, the system 102 may be configured to receive the first data 106 associated with the SWRO plant 104. The first data may include a first set of parameters associated with seawater, a second set of parameters associated with a permeate, and a third set of parameters associated with a brine. In an exemplary embodiment, the seawater may correspond to the input seawater that needs to be filtered in the SWRO plant 104. Further, the permeate may correspond to the seawater that may pass through one or more membranes of the SWRO plant 104 with reduced concentration of salts, minerals, and other impurities. The brine may correspond to seawater that may not pass through the one or more membranes of the SWRO plant 104. In other words, the permeate may refer to the purified water produced by SWRO plant 104, while brine may correspond to concentrated water left over that carries away impurities rejected by the one or more membranes of the SWRO plant 104.

In an exemplary embodiment, the first data 106 may be captured by the plurality of sensors associated with the system 102 and may include the historical data of the SWRO plant 104. In another exemplary embodiment, the received first data 106 may include real-time data of the SWRO plant 104 that may be captured by the plurality of sensors associated with the SWRO plant 104. The plurality of sensors may include be, for example, but not limited to, a Potential of Hydrogen (pH) sensor, a temperature sensor, a turbidity detector, a water level sensor, an electrical path-detecting sensor, a pressure sensor, and a conductivity sensor. The plurality of sensors may enable the system 102 to acquire real-time and accurate data associated with the SWRO plant 104.

In an exemplary embodiment, the system 102 may be configured to generate validated data based on the application of one or more data validation techniques on the received first data 106. In an alternate embodiment, the system 102 may be configured to firstly upload the received first data 106 to the server 108 and then apply the one or more data validation techniques. The one or more data validation techniques may include at least of cleaning the first data 106 and validating the first data 106. In an exemplary embodiment, the system 102 may be configured to validate the uploaded first data 106 by removing non-numeric values and outliers from the received first data 106. The one or more validation techniques may be, for example, but are not limited to, a manual inspection, range checks, format checks, consistency checks, cross-field validation, referential integrity checks, and pattern matching.

In an exemplary embodiment, the manual inspection may be a visual examination or assessment of the received first data 106 by human operators to identify errors, inconsistencies, or anomalies. Further, the range checks may be verification that the received first data 106 may fall within acceptable limits to ensure accuracy and reliability. The format checks may be validation of the data format of the received first data 106 to confirm that the received first data 106 may meet specified criteria or standards for proper processing. Further, the consistency checks may be an examination of the received first data 106 to ensure that the received first data 106 data is internally consistent. The cross-field validation may be verification that the received first data 106 relationships between different fields may be accurate and consistent to maintain data integrity. Further, the referential integrity checks may be the validation ensuring that references between different datasets or tables are valid and consistent to prevent data corruption. The pattern matching may be an identification of specific patterns or structures within the received first data 106 to match predefined formats, aiding in the validation and analysis.

Further, the cleaning of the first data 106 may include identifying and correcting errors, inconsistencies, and anomalies in the first data 106. Further, validating the first data 106 may include verifying the accuracy, integrity, and quality of the received first data 106 associated with the SWRO plant 104 through systematic checks and validation procedures. To this end, to complete the one or more data validation techniques, the system 102 may be configured to calculate the missing data and/or missing parameters for normalization of the first data 106 using a physical model that may be provided by a supplier (or a vendor) of the one or more membranes associated with the SWRO plant 104. In an exemplary embodiment, the values of the missing data and/or missing parameters in the first data 106 may be provided by the vendor. For example, the vendor may provide a maximum threshold value of the temperature that may be handled by the one or more membranes of the SWRO plant 104. The maximum threshold value of the temperature may be, for example, but not limited to 100 degrees. The system 102 may determine that the missing values for the data associated with the temperature parameter may be less than 100 degrees. Further, the system 102 may be configured to store the validated first data 106 on the server 108.

In an embodiment, the system 102 may be configured to determine a fourth set of parameters based on an application of one or more normalization techniques on the received first data 106. In an exemplary embodiment, the system 102 may be configured to generate normalized data based on the application of the one or more normalization techniques on the validated data. For example, the system 102 may be configured to process the first data 106 associated with the SWRO plant 104 by extracting the first data 106 stored in the server 108. The system 102 may be configured to determine the fourth set of parameters based on the generated normalized data. In an exemplary embodiment, the data normalization may enable fair and reliable comparison of initial performance of the one or more membranes associated with the SWRO plant 104 with the historical and real-time performance of the one or more membranes associated with the SWRO plant 104.

In an embodiment, the fourth set of parameters may include at least one of Normalized Salt Passage (NSP) of the one or more membranes associated with the SWRO plant, Normalized Differential Pressure (NDP) of the one or more membranes associated with the SWRO plant, and Normalized Permeate Flow (NPF) of the one or more membranes associated with the SWRO plant 104.

In an embodiment, the system 102 may be configured to generate diagnostic data 112 based on the fourth set of parameters to determine at least one of a set of membrane performance parameters or a set of diagnostic indicators. Further, the fourth set of parameters may provide insight into the performance of the one or more membranes. Further, the system 102 may be configured to output the determined set of membrane performance parameters or the set of diagnostic indicators.

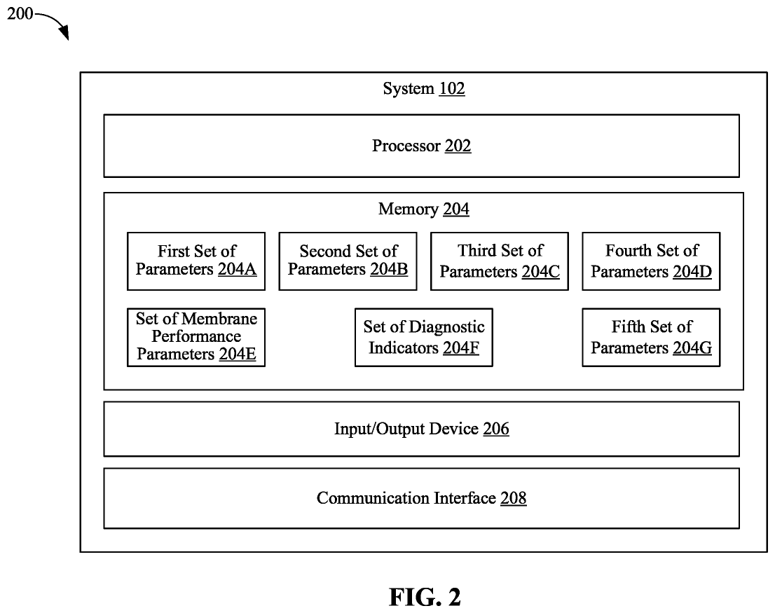

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor (referred to as a processor 202, hereinafter), at least one non-transitory memory (referred to as a memory 204, hereinafter), an input/output (I/O) device 206, and a communication interface 208. The processor 202 may be connected to the memory 204, the I/O device 206, and the communication interface 208 through one or more wired or wireless connections. The memory 204 may store a first set of parameters 204A, a second set of parameters 204B, a third set of parameters 204C, a fourth set of parameters 204D, a set of membrane performance parameters 204E, a set of diagnostic indicators 204F, and a fifth set of parameters 204G. Although in FIG. 2, it is shown that the system 102 includes the processor 202, the memory 204, the I/O device 206, and the communication interface 208 however, the disclosure may not be so limiting and the system 102 may include fewer or more components to perform the same or other functions of the system 102.

The processor 202 of the system 102 may be configured to perform one or more operations for predictive analysis for the SWRO plants. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the communication interface 208 of the system 102. The communication interface 208 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In an embodiment, the first set of parameters 204A associated with the seawater may include at least one of a pressure value of the seawater, a salinity value of the seawater, or a conductivity value of the seawater. The pressure value of the seawater refers to the force per unit area that may be exerted by the seawater on the one or more membranes associated with the SWRO plant 104. Further, the salinity value of the seawater may be the measure of the amount of dissolved salts in the seawater. It may be measured in units of g/L or g/kg (grams of salt per liter/kilogram of water). The conductivity value of the seawater may be the ability to pass electrical flow through the seawater, the conductivity value may be related to the concentration of ions present in the seawater.

Similarly, the first data 106 may further include the second set of parameters 204B which may include the pressure value, the salinity value, and the conductivity value for the permeate, and the third set of parameters 204C which may include the pressure value, the salinity value, and the conductivity value for the brine respectively. Specifically, the second set of parameters 204B associated with the permeate may include at least one of a pressure value of the permeate, a salinity value of the permeate, or a conductivity value of the permeate. The third set of parameters 204C associated with the brine may include at least one of a pressure value of the brine, a salinity value of the brine, or a conductivity value of the brine.

In an embodiment, the fourth set of parameters 204D may include at least one of the Normalized Salt Passage (NSP) values associated with one or more membranes of the SWRO plant, Normalized Differential Pressure (NDP) values associated with the one or more membranes of the SWRO plant 104, and Normalized Permeate Flow (NPF) value associated with the one or more membranes of the SWRO plant 104.

In an exemplary embodiment, the set of membrane performance parameters 204E may include, but are not limited to, the normalized permeate flow (NPF), the normalized salt passage (NSP), and the normalized differential pressure (NDP). Further, the set of diagnostic indicators 204F may include at least a Potential of Hydrogen (pH) of the seawater, a silt density Index (SDI) of the seawater, turbidity of the seawater, a temperature of the seawater, chorine value of the seawater, an oxidation-reduction potential of the seawater, and cartridge filter (CF) pressure drop. In an exemplary embodiment, the set of diagnostic indicators 204F may further include the fourth set of parameters 204D and the fifth set of parameters 204G.

In an embodiment, the fifth set of parameters 204G, may include at least one of the water transport coefficients of one or more membranes associated with the SWRO plant 104, a salt transport coefficient of the one or more membranes associated with the SWRO plant 104, and a specific flux of the one or more membranes associated with the SWRO plant 104.

In some example embodiments, the Input/Output device 206 may communicate with the system 102 and display the input and/or output of the system 102. As such, the I/O device 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O device 206 elements such as a display and, in some embodiments, a plurality of speakers, a ringer, one or more microphones and/or the like. The processor 202 and/or I/O device 206 circuitry including the processor 202 may be configured to control one or more functions of one or more I/O device 206 elements through computer program instructions (for example, software and/or firmware) stored on a memory 204 accessible to the processor 202.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

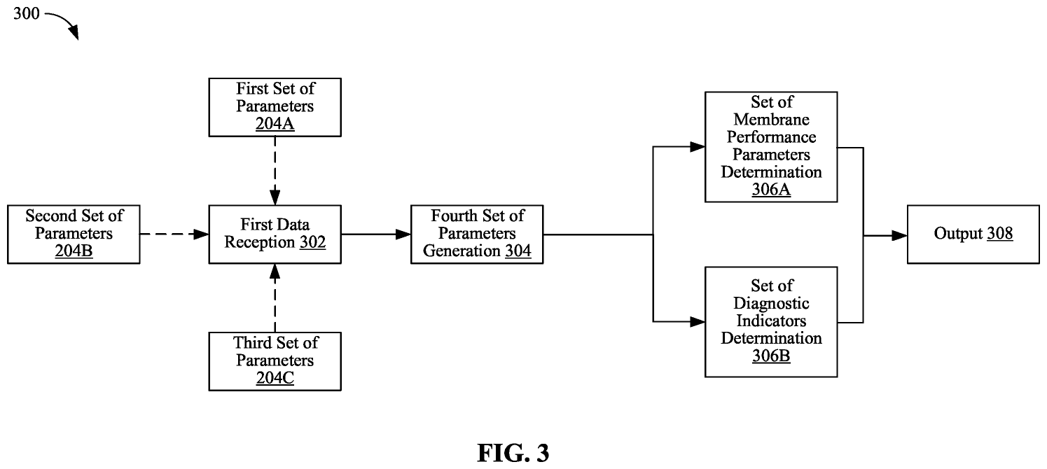

FIG. 3 illustrates exemplary operations for predictive analysis for SWRO desalination plants, in accordance with an embodiment of the disclosure. FIG. 3 is explained in conjunction with FIG. 1 and FIG. 2. In FIG. 3, there is shown a block diagram 300 of the system 102 for predictive analysis for the SWRO desalination plants. The system 102 may include a first data reception operation, a fourth set of parameters generation operation, a set of membrane performance parameters determination operation, a set of diagnostic indicators determination operation, and an output operation.

Typically in a SWRO operation, the seawater is fed into the SWRO plant for desalination. The seawater undergoes pre-treatment processes like flocculation and ultrafiltration to remove the suspended matter and prepare it for reverse osmosis. The seawater is then pressurized and forced through the one or more membranes associated with the SWRO plant 104, separating the seawater into the permeate and the brine. The permeate undergoes further treatment for disinfection and remineralization to meet quality standards, while the brine may be either disposed of or further treated for reuse. The desalinated water is collected as the product of the process, providing fresh water for various purposes.

In an exemplary embodiment, the seawater corresponds to the seawater that is fed into the SWRO plant 104 as the input for the reverse osmosis process (or the desalination process). Further, the permeate may be the product of the desalination process, consisting of fresh water that may have been passed through the one or more membranes associated with the SWRO plant 104, leaving behind the dissolved salts and other contaminants. The brine may be a rejected stream or concentrated stream of water that may remain after the desalination process. The brine may contain a higher concentration of dissolved solids and is typically a byproduct of the desalination process, requiring further treatment or disposal.

At 302, the first data reception operation may be performed. The processor 202 may be configured to perform the first data 106 reception operation. The processor 202 may be configured to receive the first data 106 associated with the SWRO plant 104. The received first data 106 may include at least one of the first set of parameters 204A associated with the seawater, the second set of parameters 204B associated with the permeate, and the third set of parameters 204C associated with the brine. In an exemplary embodiment, the received first data 106 may further include an osmotic pressure associated with the seawater. The osmotic pressure refers to a minimum pressure that must be applied to the seawater to reverse the natural osmosis process. By applying a pressure greater than the osmotic pressure, the process of reverse osmosis occurs, forcing water from the brine stream (high salt concentration) to flow towards the fresh stream (low salt concentration). Each of the one or more membranes may be, for example, a semipermeable membrane. The osmotic pressure may be determined based on the concentration of salt such as, but not limited to, sodium chloride in the seawater. As the seawater may be driven against the one or more membranes, water molecules may move from the side of lower solute concentration to the side of higher solute concentration. The movement of the water molecules may create a pressure that may be the osmotic pressure.

In another exemplary embodiment, the first data 106 may further include, a flow rate associated with at least one of the seawater, the permeate, or the brine. The flow rate of the seawater may be the rate at which the seawater may flow through one or more membranes associated with the SWRO plant 104. For example, 20 LPM (Liters Per Minute). Further, the flow rate of the permeate may be the rate at which the permeate may flow through one or more membranes associated with the SWRO plant 104. For example, the flow rate of the permeate may be, but not limited to, 15 LPM. Further, the flow rate of the brine may be the rate at which the brine may flow through one or more membranes associated with the SWRO plant 104. For example, the flow rate of the brine may be, but not limited to, 5 LPM.

In yet another exemplary embodiment, the first data 106 may further include the temperature associated with at least one of the seawater, the permeate, or the brine. The temperature may include measurement of the temperature of the seawater, the permeate, or the brine at various operations in the SWRO plant 104. The operations in the SWRO plant 104 may include, but are not limited to, an intake operation, a pre-treatment operation, or a remineralization operation. For example, the processor 202 may be configured to monitor the temperature of the seawater feed that may be entering the SWRO plant 104. Further, the processor 202 may be configured to monitor the temperature of the permeate. The permeate may be the freshwater that may be produced by the SWRO plant 104. The processor 202 may be further configured to monitor the temperature of the brine that may be further disposed of back in the seawater.

At 304, the fourth set of parameters generation operation may be performed. The processor 202 may be configured to perform the fourth set of parameters 204D generation operation based on the application of one or more normalization techniques on the received first data 106. In an embodiment, the normalization of data is a process commonly used to adjust values to a standard reference point, allowing for meaningful comparisons between different datasets. One or more normalization techniques may include the application of correction factors on parameters associated with the first data 106 such as, but not limited to, the pressure, the temperature, the flowrate, and the salinity.

The one or more normalization techniques may be performed to compare the performance of the one or more membranes associated with the SWRO plant 104 based on initial performance. The initial performance may be the performance of the one or more membranes associated with the SWRO plant 104 at the beginning of operation of the one or more membranes. The operations of the one or more membranes may include, but are not limited to, removing contaminants, removing flocs, and reducing Total Dissolved Solids (TDS) in the seawater to produce the permeate.

In an exemplary embodiment, the fourth set of parameters 204D that may be generated based on the application of one or more normalization techniques on the received first data 106 may include at least the Normalized Salt Passage (NSP) of the one or more membranes associated with the SWRO plant 104, the Normalized Differential Pressure (NDP) of the one or more membranes associated with the SWRO plant 104, and the Normalized Permeate Flow (NPF) of the one or more membranes associated with the SWRO plant 104.

In an exemplary embodiment, the NSP may be the normalized amount of salt that may pass through the one or more membranes associated with the SWRO plant 104. The salt passage may represent a fraction of salt that may pass through the one or more membranes, contributing to the concentration of salts in the permeate. Further, the processor 202 may be configured to normalize the salt passage by adjusting salt passage data associated with the SWRO plant 104 to account for variations in operating conditions, such as, but not limited to, changes in the seawater salinity, the temperature, pressure of the seawater, the flow rate of the seawater. The NSP may ensure that the salt passage data from different time periods or operating conditions may be compared accurately with the initial performance of the one or more membranes.

In another exemplary embodiment, the NDP may be a normalized measured value of the pressure difference across each of the one or more membranes associated with the SWRO plant 104. Each of the one or more membranes may be used to separate salt and impurities from the seawater, allowing permeate to pass through. The differential pressure across each of the one or more membranes associated with the SWRO plant 104 may be an important parameter that may affect the efficiency and performance of the SWRO plant 104. An increase in the differential pressure may lead to reduced productivity and efficiency in the SWRO plant 104. It may be a result of various issues like fouling, scaling, or suspended solids buildup, that may hinder water flow and increase energy consumption.

Further, the processor 202 may be configured to normalize the differential pressure by adjusting the pressure data to account for the variations in operating conditions, such as, but not limited to, changes in the seawater, the temperature, and the salinity of the seawater. The normalization of the differential pressure may ensure that the differential pressure from different time periods or operating conditions may be compared accurately with the initial performance of the one or more membranes.

In another exemplary embodiment, the NPF may be a normalized measure of the rate at which the permeate may be produced by the one or more membranes associated with the SWRO plant 104. Further, the processor 202 may be configured to normalize the permeate flow by adjusting a flow rate of the permeate to account for variations in operating conditions such as, but not limited to, changes in temperature of the permeate, pressure of the permeate, or salinity of the permeate. The normalization of the permeate flow may ensure that the permeate flow from different time periods or operating conditions may be compared accurately with the initial performance of the one or more membranes.

In an embodiment, the normalized data that may be generated based on the application of the one or more normalization techniques on the received first data 106 may include the fifth set of parameters 204G. The fifth set of parameters 204G may include at least a water transport coefficient of the one or more membranes associated with the SWRO plant 104, a salt transport coefficient of the one or more membranes associated with the SWRO plant 104, and a specific flux of the one or more membranes associated with the SWRO plant 104.

In an exemplary embodiment, the water transport coefficient may be the rate at which water molecules may pass through each of the one or more membranes per unit area under a given driving force, which may be a pressure gradient. The water transport coefficient may measure the efficiency of each of the one or more membranes in allowing the permeate to pass through while blocking the passage of solutes.

In another exemplary embodiment, the salt transport coefficient may be the rate at which salt ions may pass through a membrane per unit area under a given driving force which may be the pressure gradient. The salt transport coefficient may measure the efficiency of the each of the one or more membranes associated with the SWRO plant 104 to allow solutes to pass through while retaining the permeate. Further, the salt transport coefficient may depend on various factors, such as the properties of one or more membranes. The properties of one or more membranes may include, but are not limited to, a pore size of the one or more membranes, a surface charge of the one or more membranes, and material properties of the one or more membranes. The salt transport coefficient may further depend on the properties of the seawater, such as, but not limited to, the salt concentration of the seawater, and the operating conditions of the SWRO plant 104.

In yet another exemplary embodiment, the specific flux may be the measure of the efficiency of each of the one or more membranes to produce the permeate in relation to their surface area. For example, a higher specific flux value may indicate higher production of the permeate and higher efficiency of the one or more membranes associated with the SWRO plant 104.

At 306A, the set of membrane performance parameters 204E determination operation may be performed. The processor 202 may be configured to determine the set of membrane performance parameters 204E associated with the SWRO plant 104, based on the application of the one or more normalization techniques on the generated diagnostic data 112. Each of the set of membrane performance parameters 204E may indicate performance of the one or more membranes associated with the SWRO plant 104. In an exemplary embodiment, the membrane performance parameter may be generated based on the normalized data that may include various parameters relating to the membrane performance. For example, the various parameters may include, but are not limited to, the normalized permeate flow (NPF), the normalized salt passage (NSP), and the normalized differential pressure (NDP).

At 306B, the set of diagnostic indicators 204F determination operation may be performed. The processor 202 may be configured to determine the set of diagnostic indicators 204F based on the determined fourth set of parameters 204D. The set of diagnostic indicators 204F may include at least of the pH of the seawater, the Silt Density Index (SDI) of the seawater, the turbidity of the seawater, the temperature of the seawater, the chlorine value of the seawater, the oxidation-reduction potential of the seawater and the Cartridge Filter (CF) pressure drop.

In an exemplary embodiment, the pH of the seawater may be the measure of acidity or alkalinity of the seawater. The pH of the seawater may depend on multiple factors such as, but not limited to, the location, and the temperature.

In another exemplary embodiment, the SDI of the seawater may be the measure of the fouling potential of suspended solids in the seawater. The suspended solids may be insoluble solid particles that may be dispersed in the seawater. The suspended solids may vary in size, shape, and composition.

In another exemplary embodiment, the turbidity of the seawater may correspond to cloudiness or haziness of the seawater that may be caused by suspended particles or colloidal matter that may be present in the seawater. The turbidity may be the measure of the optical properties of the seawater and may indicate a degree to which the light may be scattered or absorbed by the suspended particles. Further, the chlorine value of the seawater may be the concentration of the chlorine that may be present in the seawater. The chlorine may be used for disinfection and sanitation purposes in the SWRO plant 104.

In yet another exemplary embodiment, the oxidation-reduction potential of the seawater may be used to provide insights into the effectiveness of one or more membranes. For example, changes in oxidation-reduction potential may indicate potential fouling, degradation, or damage of the one or more membranes associated with the SWRO plant 104. A decrease in oxidation-reduction potential may indicate the presence of foulants or biofilm accumulation on the surface of one or more membranes associated with the SWRO plant 104 that may affect the quality of the permeate and production efficiency of the SWRO plant 104.

In an exemplary embodiment, the Cartridge Filter (CF) pressure drop may be the decrease in pressure that may occur as the seawater passes through the cartridge filter. The cartridge filter may be used in the SWRO plant 104 to remove the suspended solids, particles, and other contaminants from the seawater. The cartridge filter pressure drop may be affected by factors such as, but not limited to, filter media, contaminant load, flow rate, filter condition, and filter design.

At 308, the output operation may be performed. The processor 202 may be configured to output the determined set of membrane performance parameters 204E or the set of diagnostic indicators 204F. In an exemplary embodiment, the output of the determined set of membrane performance parameters 204E or the set of diagnostic indicators 204F may be displayed on an electronic device such as, but not limited to, a laptop, a desktop, or a mobile device. In another exemplary embodiment, the processor 202 may be configured to store the determined set of membrane performance parameters 204E or the set of diagnostic indicators 204F in the server 108.

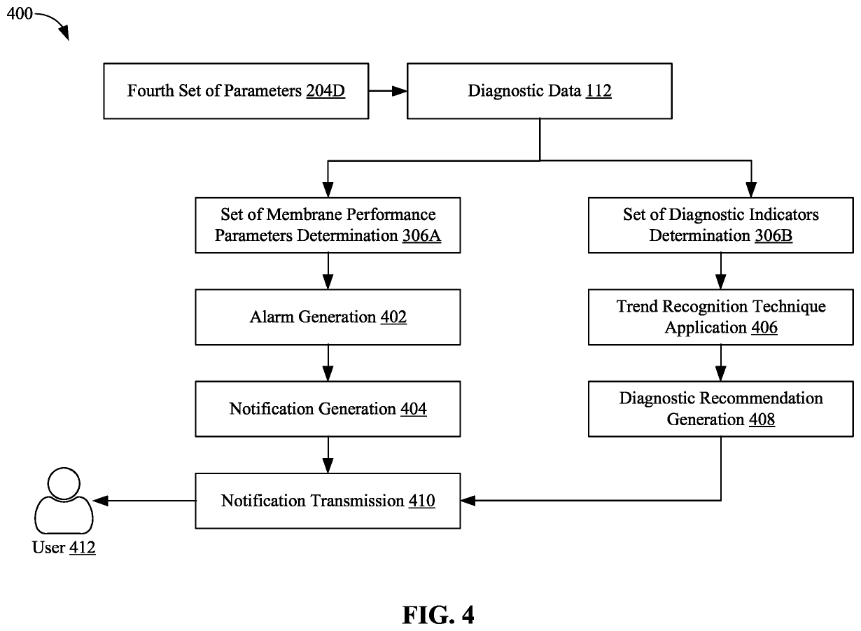

FIG. 4 illustrates a flowchart for the implementation of exemplary method 400 for generating diagnostic recommendations for monitoring the SWRO process, in accordance with an example embodiment of the present disclosure. FIG. 4 is explained in conjunction with FIG. 1, FIG. 2, and FIG. 3. In FIG. 4, there is shown a flowchart of the system 102 for generating diagnostic recommendations for monitoring the SWRO process.

In an embodiment, the processor 202 may be configured to receive the first data 106 associated with the SWRO plant 104. The received first data 106 may include at least one of the first set of parameters 204A associated with the seawater, the second set of parameters 204B associated with the permeate, and the third set of parameters 204C associated with the brine. Further, the processor 202 may be further configured to determine the fourth set of parameters 204D based on the application of the one or more normalization techniques on the received first data 106.

Further, based on the fourth set of parameters 204D, the diagnostic data 112 may be generated. The processor 202 may determine at least one of the set of membrane performance parameters 204E associated with the SWRO plant 104, or the set of diagnostic indicators 204F associated with at least one of the SWRO plant 104 and the seawater based on the determined diagnostic data 112. The details about the fourth set of parameters 204D, the set of membrane performance parameters 204E, and the set of diagnostic indicators 204F are provided in FIG. 3.

In an embodiment, the processor 202 may be further configured to compare the value of each parameter of the set of membrane performance parameters 204E with a corresponding threshold value. Further, the processor 202 may be configured to generate an alarm based on the comparison. In an exemplary embodiment, the alarm generation operation at 402 may take place based on the compared value of at least one parameter of the set of membrane performance parameters 204E is less than the corresponding threshold value.

In an exemplary case, the set of membrane performance parameters 204E may include the Normalized Permeate Flow (NPF). The processor 202 may be configured to compare the value of NPF with a corresponding threshold value of the NPF. The threshold value for the NPF may be, for example, 0.95. The compared value being less than the corresponding threshold value may indicate a potential issue with the one or more membrane associated with the SWRO plant 104. The processor 202 may compare the value of the NPF that may be received from the SWRO plant 104 with the threshold value of the NPF. The value of the NPF that may be received from the SWRO plant 104 may be, for example, 0.80. Based on the comparison, the processor 202 may determine that the compared value of the NPF is less than the corresponding threshold value. Further, the processor 202 may generate an alarm based on the comparison.

In an embodiment, the processor 202 may be configured to perform a notification generation operation at 404. The processor 202 may generate a notification based on the generated alarm. The generated notification may indicate the generated alarm. Further, the processor 202 may be configured to perform a transmit to the electronic device operation at 410 by transmitting the generated notification to an electronic device. In an exemplary embodiment, the electronic device may be associated with user 414 who may be an operator of the SWRO plant 104. The electronic device may be, for example, but are not limited to, a smartphone, a laptop, a tablet, and a desktop.

In an embodiment, the processor 202 may be configured to determine a trend in a set of diagnostic indicators 204F that may be used in the SWRO plant 104. The set of diagnostic indicators 204F may be measurable parameters that may be used to assess the performance of the one or more membranes associated with the SWRO plant 104. The processor 202 may be configured to determine one or more diagnostic indicators based on the generated diagnostic data 112 to determine the diagnostic indicator trend in each of the set of diagnostic indicators 204F.

Further, the set of diagnostic indicators 204F may include at least, but are not limited to, a Potential of Hydrogen (pH) of the seawater, a silt density Index (SDI) of the seawater, a turbidity of the seawater, a temperature of the seawater, chorine value of the seawater, an oxidation-reduction potential of the seawater, and cartridge filter (CF) pressure drop.

In an embodiment, the processor 202 may be configured to generate second data based on a combination of the determined set of membrane performance parameters 204E and the determined set of diagnostic indicators 204F. Further, a diagnostic indicator trend may be recognized by applying a trend recognition technique to the generated second data. The diagnostic indicator trend recognition may be the process of analyzing and identifying patterns, trends, or deviations in the set of diagnostic indicators 204F over a time period. The diagnostic indicator trend recognition may include determining the trend in different indicators used to monitor the performance of the one or more membranes associated with the SWRO plant 104.

Further, the processor 202 may be configured to apply a trend recognition technique on the generated second data. Specifically, the processor 202 may perform the trend recognition technique application operation at 406. Further, the processor 202 may be configured to determine the diagnostic indicator trend in each of the set of diagnostic indicators 204F based on the application of the trend recognition technique.

In an exemplary embodiment, the processor 202 may analyze the trend in the SDI, the turbidity, pH, and the temperature of the seawater over the time period by applying the trend recognition technique to the second data. The time period may be, for example, but not limited to, 1 week, 1 month, 1 year, and 3 years. The processor 202 may generate a cleaning in Place (CIP) prediction to provide a CIP timeline and a diagnostic recommendation based on the determined diagnostic indicator trend. The cleaning in Place (CIP) prediction may be the prediction of when a Clean in Place process may be conducted based on determined diagnostic indicators and the historical data associated with the SWRO plant 104. The CIP may be the process of cleaning the one or more membranes associated with the SWRO plant 104 without disassembling the one or more membranes. Further, the CIP timeline may be the schedule or timeline for conducting CIP procedures.

Further, to conduct the CIP prediction, the real-time data may be smoothened to ensure efficient and proper forecasting. The smoothing of real-time data associated with the received first data 106 may include analyzing patterns in the real-time data for the CIP prediction. The processor 202 may further perform diagnostic recommendation generation operation at 408 that may assist the user 412 in identifying, troubleshooting, and resolving issues to optimize SWRO plant 104 performance. Upon the application of the trend recognition technique, the processor 202 may perform the transmit to electronic device operation at 410 by outputting the CIP timeline and the diagnostic recommendation on the electronic device associated with user 412. In an exemplary embodiment, the user 412 may be an operator or a maintenance personnel associated with the SWRO plant 104.

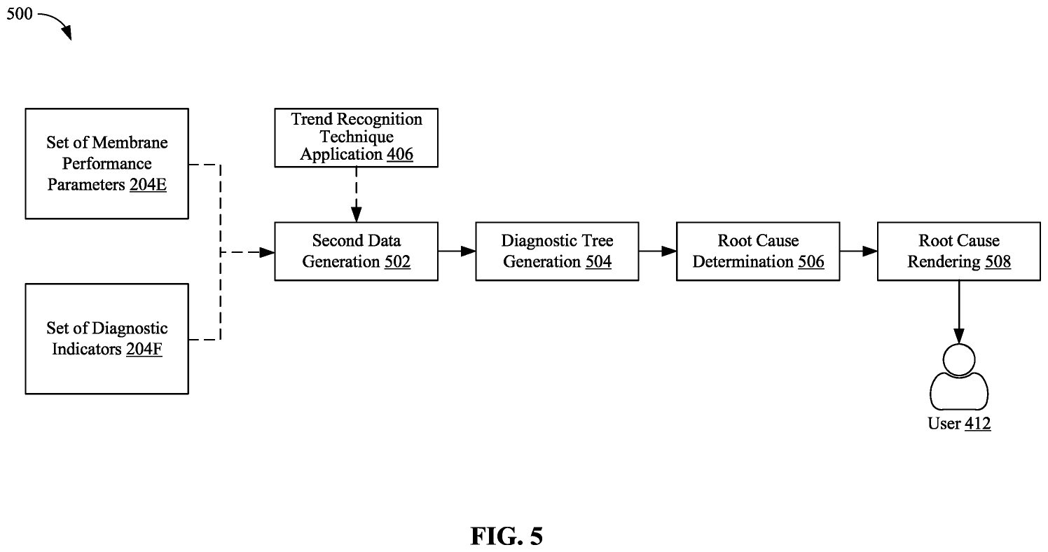

FIG. 5 illustrates a flow diagram 500 for the determination of the root cause for a decline in the performance of the one or more membranes of the SWRO plant 104, in accordance with an example embodiment of the present disclosure. FIG. 5 is explained in conjunction with FIG. 1, FIG. 2, FIG. 3, and FIG. 4. In FIG. 5 there is flow diagram 500 of the system 102 for determining the root cause of a decline in the performance of the one or more membranes of the SWRO plant 104.

A diagnostic tree may be a structured approach that may be used to analyze and diagnose issues related to fouling or decline in the performance of the one or more membranes associated with the SWRO plant 104. By systematically examining various characteristics and properties of the one or more membranes associated with the SWRO plant 104 such as, but not limited to, the second data. The diagnostic tree aids in identifying the causes of fouling or decline in the performance of the one or more membranes associated with the SWRO plant 104 for effective troubleshooting and maintenance.

In an embodiment, the processor 202 may be configured to generate the diagnostic tree based on the second data. The processor 202 may be configured to perform a second data generation operation at 502. Further, the processor 202 may be configured to perform a diagnostic tree generation operation at 504 based on the application of the trend recognition technique on the second data. The processor 202 may be configured to determine the second data by combining the set of membrane performance parameters 204E and the set of diagnostic indicators 204F. The details about the set of membrane performance parameters 204E and the set of diagnostic indicators 204F are provided in FIG. 3. Further, the details about the trend recognition technique application and the second data are provided in FIG. 4.

In an exemplary embodiment, the diagnostic tree may include at least two parameters. Further, the processor 202 may be configured to determine a root cause for the decline in performance of one or more membranes associated with the SWRO plant 104, based on the generated diagnostic tree. The diagnostic tree may be used to determine the possible root cause based on the trend recognized for each of the plurality of parameters.

In an exemplary embodiment, the diagnostic tree may be based on the trend recognition results of several parameters. Thus, based on diagnostic library combined with newly generated diagnostic tree, the system can generate output for root cause and operational recommendation. The diagnostic library consists of lessons learned from historical operational data and membrane autopsy reports that links sets of parameters (normalized performance data and additional indicators) with the root causes.

In an exemplary case, for generating the diagnostic tree, a trend for the NDP may be determined. The trend of the NDP determined for a period of time, for example, but not limited to, 1 week, may be either an increasing trend, a decreasing trend, or a no trend. The increasing trend may signify the increasing measured value of the corresponding parameter, the decreasing trend may signify a decrease in the value of the corresponding parameter, and the no trend may signify no change in the measured value of the corresponding parameter. Further, based on the recognized trend for the NDP, the recognized trend for the NPF may be combined to form a series. Furthermore, continuing with the series, the trend for each of the plurality of parameters may be determined and combined with a recognized trend of previous parameters up till the recognized trend for each parameter of the diagnostic data 112. Further, the root cause may be determined based on the generated diagnostic tree. The determined root cause may signify the decline in the performance of at least one of the one or more membranes.

In an exemplary embodiment, for the trend recognition process, the system 102 may utilize a statistical test for example, but not limited to, the Mann-Kendall (MK) trend test. The statistical test may be performed based on a sequential comparison of the magnitude of the next and previous values of a parameter such as, but not limited to, the NDP and the NPF to assess whether a set of data values may be increasing over time or decreasing over time and whether the trend in either direction (increasing or decreasing) may be statistically significant that may be determined as per an expression (1) described below:

$$S = {\sum }_{k = 1}^{n - 1} {\sum }_{j = k + 1}^{n} f ( {x}_{j} - {x}_{k} ) \qquad ( 1 )$$

In the abovementioned expression (1), xⱼ is the next value of a parameter recorded just after the previous i.e., xₖ.value. In the expression (1), a positive value of S may indicate an increasing trend, while a negative value of S may indicate a decreasing trend. However, in a case when the value of S may be equal to zero, the trend may neither be increasing nor decreasing. Further, the recognized trend from the diagnostic data 112 may be fed into the diagnostic tree. The diagnostic tree may enable the transformation of multiple trends into the possible root cause of a decline in the membrane performance. In an exemplary embodiment, if values of the NPF are for example, [0.2, 0.3, 0.25, 0.35, 0.28], then n may represent a total number of values, for example, n=5, the value of (n−1) will be 4. In a case where k=1, the value of Xⱼ may be 0.3, and the value of Xₖ may be 0.2. Furthermore, in a case where k=2, the value of Xⱼ may be 0.25, and the value of Xₖ may be 0.3.

Further, the system 102 may provide the CIP timeline prediction based on a value of the NPF and a value of the NDP. To this end, the system 102 may utilize multiple regression options (for example, the Ridge regressor) on forecasting techniques (or algorithms), such as Forecast Autoreg to estimate the CIP timing based on the threshold value of the parameters such as a maximum allowable value of the NPF and the NDP

Further, the processor 202 may be configured to perform root cause rendering operation at 508. In the root cause rendering operation at 508, the processor 202 may be configured to output the root cause on an electronic device that may be associated with the user 412. In an exemplary embodiment, the electronic device may be associated with a user 414 who may be an operator of the SWRO plant 104. The electronic device may be, for example, but are not limited to, a smartphone, a laptop, a tablet, and a desktop.

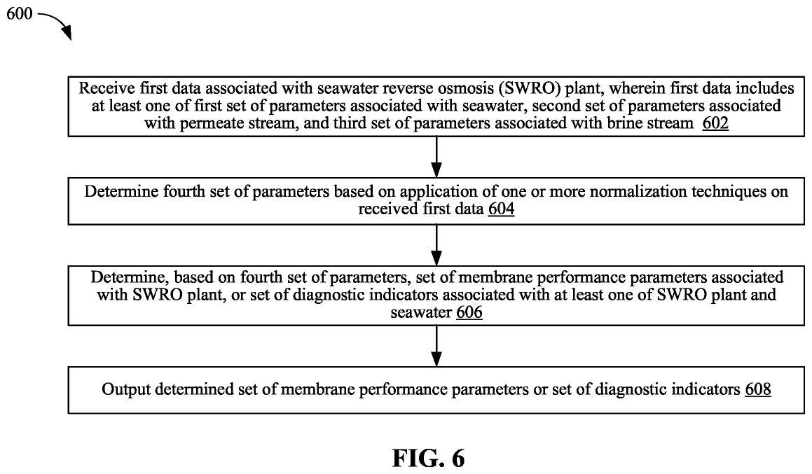

FIG. 6 is a flowchart that illustrates an exemplary method for predictive analysis for seawater reverse osmosis desalination plants, in accordance with an embodiment. FIG. 6 is explained in conjunction with elements of FIG. 1, FIG. 2, FIG. 3, FIG. 4, and FIG. 5. With reference to FIG. 6, there is shown a flowchart 600. The operations of the exemplary method may be executed by any computing system, for example, by the system 102 of FIG. 1 or the processor 202 of FIG. 2. The operations of the flowchart 600 may start at 602.

At 602, the first data 106 associated with the SWRO plant 104 may be received. The first data 106 may include at least one of the first set of parameters 204A associated with the seawater, the second set of parameters 204B associated with the permeate, and the third set of parameters 204C associated with the brine. In an embodiment, the processor 202 may be configured to receive the first data 106 associated with the SWRO plant 104. The first data 106 may include at least one of the first set of parameters 204A associated with the seawater, the second set of parameters 204B associated with the permeate, and the third set of parameters 204C associated with the brine.

At 604, the fourth set of parameters 204D may be determined based on application of the one or more normalization techniques on the received first data 106. In an embodiment, the processor 202 may be configured to determine the fourth set of parameters 204D based on the application of the one or more normalization techniques on the received first data 106.

At 606, the set of membrane performance parameters 204E associated with the SWRO plant 104 or the set of diagnostic indicators 204F associated with at least one of the SWRO plant 104 and the seawater may be determined based on the fourth set of parameters 204D. In an embodiment, the processor 202 may be configured to determine, based on the fourth set of parameters 204D, the set of membrane performance parameters 204E associated with the SWRO plant 104 or the set of diagnostic indicators 204F associated with at least one of the SWRO plant 104 and the seawater.

At 608, the determined set of membrane performance parameters 204E or the set of diagnostic indicators 204F may be output. In an embodiment, the processor 202 may be configured to output the determined set of membrane performance parameters 204E or the set of diagnostic indicators 204F.

Alternatively, the system 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium having stored thereon computer-executable instructions, which when executed by one or more processors (such as the processor 202), cause the one or more processors to carry out operations to operate a system (e.g., the system 102) for predictive analysis for the seawater reverse osmosis desalination plants. The instructions may cause the machine and/or computer to perform operations including receiving first data associated with a Seawater Reverse Osmosis (SWRO) plant. The first data may include at least one of a first set of parameters associated with seawater, a second set of parameters associated with a permeate, and a third set of parameters associated with a brine. The operations may further include determining a fourth set of parameters based on an application of one or more normalization techniques on the received first data. Further, the operations may include determining, based on the fourth set of parameters, a set of membrane performance parameters associated with the SWRO plant, or a set of diagnostic indicators associated with at least one of the SWRO plant and the seawater. The operations may further include outputting the determined set of membrane performance parameters or the set of diagnostic indicators.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
a memory configured to store a computer-executable instructions; and
one or more processors coupled to the memory, wherein the one or more processors are configured to:
receive first data associated with a seawater reverse osmosis (SWRO) plant, wherein the first data comprises at least one of: a first set of parameters associated with seawater, a second set of parameters associated with a permeate, and a third set of parameters associated with a brine;
determine a fourth set of parameters based on an application of one or more normalization techniques on the received first data;
determine, based on the fourth set of parameters, a set of membrane performance parameters associated with the SWRO plant, or a set of diagnostic indicators associated with at least one of: the SWRO plant and the seawater; and
output the determined set of membrane performance parameters or the set of diagnostic indicators.

2. The system of claim 1, wherein the one or more processors are further configured to:
generate second data based on a combination of the determined set of membrane performance parameters and the determined set of diagnostic indicators;
apply a trend recognition technique on the generated second data;
determine diagnostic indicator trend in each of the set of diagnostic indicators based on the application of the trend recognition technique; and
generate a cleaning in Place (CIP) prediction to provide a CIP timeline and a diagnostic recommendation based on the determined diagnostic indicator trend.

3. The system of claim 2, wherein the one or more processors are further configured to output the CIP timeline and the diagnostic recommendation on an electronic device.

4. The system of claim 2, wherein the one or more processors are further configured to:
generate a diagnostic tree based on the second data;
determine a root cause for a decline in performance of one or more membranes associated with the SWRO plant, based on the generated diagnostic tree; and
output the root cause on an electronic device.

5. The system of claim 1, wherein the first set of parameters associated with the seawater comprise at least one of: a pressure value of the seawater, a salinity value of the seawater, or a conductivity value of the seawater, and wherein the second set of parameters associated with the permeate comprises at least one of: a pressure value of the permeate, a salinity value of the permeate, or a conductivity value of the permeate.

6. The system of claim 1, wherein the third set of parameters associated with the seawater comprises at least one of: a pressure value of the brine, a salinity value of the brine, or a conductivity value of the brine.

7. The system of claim 1, the one or more processors are further configured to:
generate validated data based on the application of one or more data validation techniques on the received first data;
generate normalized data based on the application of the one or more normalization techniques on the validated data; and
determine the fourth set of parameters based on the generated normalized data.

8. The system of claim 7, wherein the fourth set of parameters comprises at least one of: Normalized Salt Passage (NSP) values associated with one or more membranes of the SWRO plant, Normalized Differential Pressure (NDP) values associated with the one or more membranes of the SWRO plant, and Normalized Permeate Flow (NPF) value associated with the one or more membranes of the SWRO plant.

9. The system of claim 7, wherein the generated normalized data further comprises a fifth set of parameters, and wherein the fifth set of parameters comprises at least one of: a water transport coefficient of one or more membranes associated with the SWRO plant, a salt transport coefficient of the one or more membranes associated with the SWRO plant, and a specific flux of the one or more membranes associated with the SWRO plant.

10. The system of claim 1, the one or more processors are further configured to:
generate diagnostic data based on the fourth set of parameters; and
determine, based on the generated diagnostic data, at least one of: the set of membrane performance parameters associated with the SWRO plant, or the set of diagnostic indicators associated with at least one of the SWRO plant and the seawater.

11. The system of claim 10, wherein the set of diagnostic indicators comprises at least of: a Potential of Hydrogen (pH) of the seawater, a silt density Index (SDI) of the seawater, a turbidity of the seawater, a temperature of the seawater, chorine value of the seawater, an oxidation-reduction potential of the seawater, and cartridge filter (CF) pressure drop.

12. The system of claim 10, wherein the one or more processors are further configured to determine the set of membrane performance parameters, based on the application of the one or more normalization techniques on the generated diagnostic data, and wherein each parameter of the set of membrane performance parameters indicates performance of one or more membranes associated with the SWRO plant.

13. The system of claim 12, wherein the one or more processors are configured to:
compare a value of each parameter of the set of membrane performance parameters with a corresponding threshold value; and
generate an alarm based on the comparison.

14. The system of claim 13, wherein the alarm is generated based on the compared value of at least one parameter of the set of membrane performance parameters being less than the corresponding threshold value.

15. The system of claim 13, wherein the one or more processors are further configured to:
generate a notification based on the generated alarm, wherein the generated notification indicates the generated alarm; and
transmit the generated notification to an electronic device.

16. A method, comprising:
receiving first data associated with a seawater reverse osmosis (SWRO) plant, wherein the first data comprises at least one of: a first set of parameters associated with seawater, a second set of parameters associated with a permeate, and a third set of parameters associated with a brine;
determining a fourth set of parameters based on an application of one or more normalization techniques on the received first data;
determining, based on the fourth set of parameters, a set of membrane performance parameters associated with the SWRO plant, or a set of diagnostic indicators associated with at least one of: the SWRO plant and the seawater; and
outputting the determined set of membrane performance parameters or the set of diagnostic indicators.

17. The method of claim 16, further comprising:
generating second data based on a combination of the determined set of membrane performance parameters and the determined set of diagnostic indicators;
applying a trend recognition technique on the generated second data;
determining diagnostic indicator trend in each of the set of diagnostic indicators based on the application of the trend recognition technique; and
generating a cleaning in Place (CIP) prediction to provide a CIP timeline and a diagnostic recommendation based on the determined diagnostic indicator trend.

18. The method of claim 17, further comprising outputting the CIP timeline and the diagnostic recommendation on an electronic device.

19. The method of claim 17, further comprising:
generating a diagnostic tree based on the second data;
determining a root cause for a decline in performance of one or more membranes associated with the SWRO plant, based on the generated diagnostic tree; and
outputting the root cause on an electronic device.

20. A non-transitory computer-readable medium having stored thereon, computer-executable instructions that when executed by a processor of a system, causes the processor to execute operations, the operations comprising:
receiving first data associated with a seawater reverse osmosis (SWRO) plant, wherein the first data comprises at least one of: a first set of parameters associated with seawater, a second set of parameters associated with a permeate, and a third set of parameters associated with a brine;
determining a fourth set of parameters based on an application of one or more normalization techniques on the received first data;
determining, based on the fourth set of parameters, a set of membrane performance parameters associated with the SWRO plant, or a set of diagnostic indicators associated with at least one of: the SWRO plant and the seawater; and
outputting the determined set of membrane performance parameters or the set of diagnostic indicators.
